(19) United States
(12) Patent Application Publication
(10) Pub. No.: US 2013/0167640 A1
(43) Pub. Date: Jul. 4, 2013

(54) INERTIAL SENSOR AND METHOD OF MANUFACTURING THE SAME

(71) Applicants: Seung Mo Lim, Gyunggi-do (KR); Sung Jun Lee, Gyunggi-do (KR); Sang Jin Kim, Gyunggi-do (KR); Yun Sung Kang, Gyunggi-do (KR); Kyo Yeol Lee, Gyunggi-do (KR)

(72) Inventors: Seung Mo Lim, Gyunggi-do (KR); Sung Jun Lee, Gyunggi-do (KR); Sang Jin Kim, Gyunggi-do (KR); Yun Sung Kang, Gyunggi-do (KR); Kyo Yeol Lee, Gyunggi-do (KR)

(73) Assignee: SAMSUNG ELECTRO-MECHANICS CO., LTD., Gyunggi-do (KR)

(21) Appl. No.: 13/402,373

(22) Filed: Feb. 22, 2012

(30) Foreign Application Priority Data
Dec. 29, 2011 (KR) 1020110146076

(51) Int. Cl. G01P 15/00; B32B 38/10; B32B 37/12

(52) U.S. Cl. 73/514.01; 156/325; 216/34

(57) ABSTRACT

Disclosed is an inertial sensor, including a membrane, a mass body provided underneath a central portion of the membrane, a post provided underneath a peripheral portion of the membrane, and a cap having a peripheral portion bonded to a lower surface of the post using low-temperature silicon direct bonding. A method of manufacturing the inertial sensor is also provided.

### CROSS-REFERENCE TO RELATED APPLICATION

This application claims the benefit of Korean Patent Application No. 10-2011-0146076, filed Dec. 29, 2011, entitled “Inertial sensor and method of manufacturing the same,” which is hereby incorporated by reference in its entirety into this application.

### BACKGROUND OF THE INVENTION

1. Technical Field

The present invention relates to an inertial sensor and method of manufacturing the same.

2. Description of the Related Art

Recently, an inertial sensor has been utilized in a variety of fields including not only military applications such as artificial satellites, missiles, drones, etc., but also vehicle products, such as airbags, ESC (Electronic Stability Control), black boxes for vehicles, etc., steadyshot camcorders, motion sensing for mobile phones or game machines, navigations, etc.

In order to measure acceleration and an angular velocity, such an inertial sensor is typically configured such that a mass body is bonded to an elastic substrate such as a membrane. By means of such a configuration, the inertial sensor is able to measure an inertial force that is applied to the mass body in order to determine the acceleration, or to measure a Coriolis force applied to the mass body in order to determine the angular velocity.

Specifically, measurement of the acceleration and the angular velocity using the inertial sensor is carried out as follows: the acceleration may be determined from Newton's law of motion of F=ma wherein F is the inertial force applied to the mass body, m is the mass of the mass body and a is the acceleration to be measured. When the inertial force F applied to the mass body is detected and divided by the mass m of the mass body which is a predetermined value, the acceleration a may be determined. Also, the angular velocity may be determined by the Coriolis force of F=2mΩ×v, wherein F is the Coriolis force applied to the mass body, m is the mass of the mass body, Ω is the angular velocity to be measured, and v is the motion velocity of the mass body. Because the motion velocity v and the mass m of the mass body are previously detected, the Coriolis force F applied to the mass body is detected, from which the angular velocity Ω may then be determined.

As disclosed in Korean Unexamined Patent Publication No. 10-2011-0072229, the conventional inertial sensor includes a mass body disposed under a membrane (diaphragm). In such a configuration, when the acceleration a is measured using the inertial force F, a displacement is generated on the mass body by the inertial force F. When the angular velocity Ω is measured using the Coriolis force F, the mass body should be driven at a predetermined motion velocity v. Ultimately to measure the acceleration a or the angular velocity Ω, a displacement is essentially generated on the mass body. Thus, a cap should be provided under a fixed part (a post) so as to protect the mass body on which a displacement occurs.

However, in the case of the conventional inertial sensor, a cap is bonded to the lower surface of a post using an adhesive such as for example a polymer. In the bonding process using an additive, it is difficult to form the adhesive at a uniform thickness because of the inherent properties of the polymer and the properties of the bonding process. If the thickness of the adhesive is not uniform, an error may undesirably occur upon driving the mass body or sensing the acceleration a or the angular velocity Ω. Furthermore, it is not easy to measure the thickness of the adhesive, making it difficult to detect bonding defects.

### SUMMARY OF THE INVENTION

Accordingly, the present invention has been made keeping in mind the problems encountered in the related art and an aspect of the present invention is to provide an inertial sensor and a method of manufacturing the same, wherein a cap may be bonded to a post using low-temperature silicon direct bonding, thus obviating the use of an additive and thereby preventing problems occurring as a result of the adhesive not being formed to a uniform thickness.

According to an embodiment of the present invention, an inertial sensor comprises a membrane, a mass body provided underneath a central portion of the membrane, a post provided underneath a peripheral portion of the membrane, and a cap having a peripheral portion bonded to a lower surface of the post using low-temperature silicon direct bonding.

As such, the low-temperature silicon direct bonding may comprise (A) subjecting the peripheral portion of the cap and the lower surface of the post to dry etching, (B) exposing the peripheral portion of the cap and the lower surface of the post to deionized water, and (C) bringing the peripheral portion of the cap and the lower surface of the post into close contact with each other so as to be mutually bonded.

Also in (A), the peripheral portion of the cap and the lower surface of the post may be subjected to dry etching, thus exposing a dangling atom in a state of not being coupled, in (B), the peripheral portion of the cap and the lower surface of the post may be exposed to deionized water, thus coupling the dangling atom with an OH group, and in (C), the peripheral portion of the cap and the lower surface of the post may be brought into close contact with each other, so that they are mutually bonded by Van der Waals force.

Also in (A), the dry etching may be reactive ion etching.

Also, thermally treating the peripheral portion of the cap and the lower surface of the post may be additionally performed, after (C).

Furthermore, such thermally treating may be performed using annealing at 200° C. or less.

Furthermore, such thermally treating may be performed using a hot plate.

Also, drying the peripheral portion of the cap and the lower surface of the post may be additionally performed, after (B).

Also, the cap may have a cavity depressed in a thickness direction.

Furthermore, the cavity may have a stopper that protrudes in a direction of the mass body.

According to another embodiment of the present invention, a method of manufacturing an inertial sensor comprises (A) preparing a base member comprising a membrane, a mass body provided underneath a central portion of the membrane and a post provided underneath a peripheral portion of the membrane, and a cap, and (B) bonding a peripheral portion of the cap and a lower surface of the post to each other using low-temperature silicon direct bonding.

As such, (B) may comprise (B1) subjecting the peripheral portion of the cap and the lower surface of the post to dry etching, (B2) exposing the peripheral portion of the cap and the lower surface of the post to deionized water, and (B3) bringing the peripheral portion of the cap and the lower surface of the post into close contact with each other so that they are mutually bonded.

Also in (B1), the peripheral portion of the cap and the lower surface of the post may be subjected to dry etching, thus exposing a dangling atom in a state of not being coupled, in (B2), the peripheral portion of the cap and the lower surface of the post may be exposed to deionized water, thus coupling the dangling atom with an OH group, and in (B3), the peripheral portion of the cap and the lower surface of the post may be brought into close contact with each other, so that they are mutually bonded by Van der Waals force.

Also in (B1), the dry etching may be reactive ion etching.

Also, thermally treating the peripheral portion of the cap and the lower surface of the post may be additionally performed, after (B3).

Furthermore, such thermally treating may be performed using annealing at 200° C. or less.

Furthermore, such thermally treating may be performed using a hot plate.

Also, drying the peripheral portion of the cap and the lower surface of the post may be additionally performed, after (B2).

Also, the cap may have a cavity depressed in a thickness direction.

Furthermore, the cavity may have a stopper that protrudes in a direction of the mass body.

### BRIEF DESCRIPTION OF THE DRAWINGS

FIGS. 1A and 1B are cross-sectional views showing an inertial sensor according to an embodiment of the present invention;

FIGS. 2A, 2B, 3A and 3B are cross-sectional views sequentially showing a process of manufacturing an inertial sensor according to an embodiment of the present invention;

FIGS. 4 to 7 are chemical structure views sequentially showing a process of bonding the cap and the post of FIGS. 3A and 3B using low-temperature silicon direct bonding; and

FIG. 8 is a graph showing the bonding strength according to the present invention and the conventional case.

### DESCRIPTION OF SPECIFIC EMBODIMENTS

The features and advantages of the present invention will be more clearly understood from the following detailed description and embodiments. Throughout the drawings, the same reference numerals are used to refer to the same or similar elements. Furthermore, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

Hereinafter, a detailed description will be given of embodiments of the present invention with reference to the appended drawings.

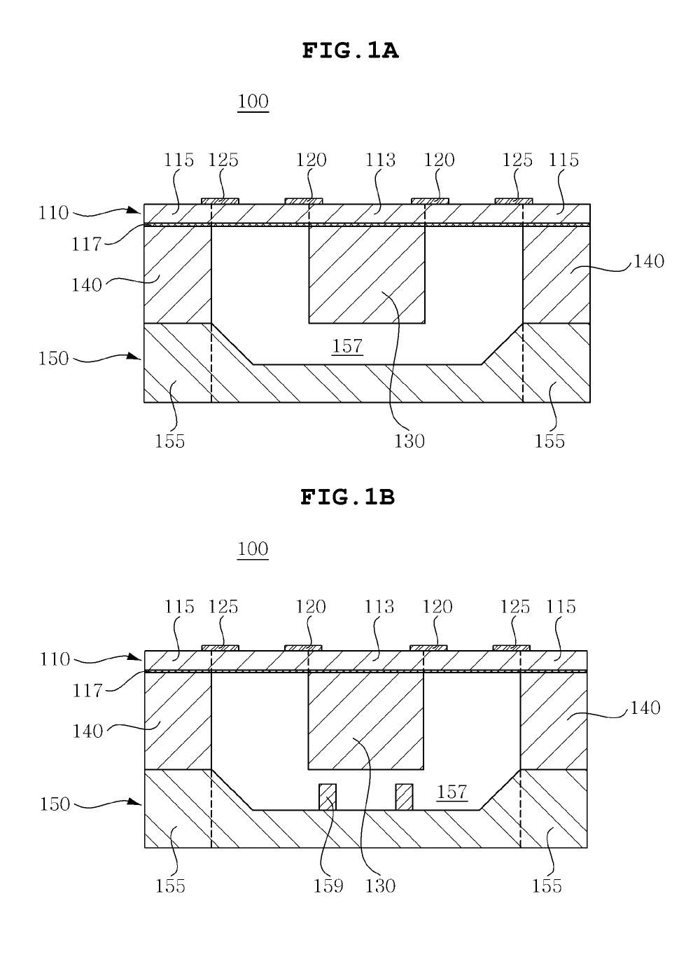

FIGS. 1A and 1B are cross-sectional views showing an inertial sensor according to embodiment of the present invention.

As shown in FIGS. 1A and 1B, the inertial sensor 100 according to the present embodiment includes a membrane 110, a mass body 130 provided underneath the central portion 113 of the membrane 110, a post 140 provided underneath the peripheral portion 115 of the membrane 110, and a cap 150 having a peripheral portion 155 bonded to the lower surface of the post 140 using low-temperature silicon direct bonding.

The membrane 110 is formed in a planar shape and has elasticity so that a mass body 130 may cause a displacement. Although the boundary of the membrane 110 is not exactly distinguished, as shown in the drawings, the membrane 110 may include the central portion 113 and the peripheral portion 114 provided along the contour of the membrane 110. The mass body 130 is provided underneath the central portion 113 of the membrane 110, and the post 140 may be provided underneath the peripheral portion 115 of the membrane 110. Thus, the peripheral portion 115 of the membrane 110 is fixed by the support of the post 140, and a displacement corresponding to the motion of the mass body 130 is generated at the central portion 113 of the membrane 110 with respect to the peripheral portion 115 of the membrane 110 which is fixed. On the other hand, elastic deformation may occur between the central portion 113 of the membrane 110 and the peripheral portion 115 thereof, and thus driving means 120 may be disposed to vibrate the mass body 130 or sensing means 125 may be disposed to measure the displacement of the mass body 130. The driving means 120 and the sensing means 125 need not be necessarily disposed between the central portion 113 of the membrane 110 and the peripheral portion 115 thereof, and as shown in the drawing, parts thereof may be disposed at the central portion 113 or the peripheral portion 115 of the membrane 110. The driving means 120 may be embodied in a piezoelectric or capacitive manner, and the sensing means 125 may be embodied in a piezoelectric, piezoresistive or capacitive manner.

The mass body 130 and the post 140 are specified below. The mass body 130 is provided underneath the central portion 113 of the membrane 110 thus generating a displacement by an inertial force or Coriolis force. Also, the post 140 is formed in a hollow shape to support the understructure of the peripheral portion 115 of the membrane 110 and thereby plays a role in ensuring a space where the mass body 130 may cause a displacement. The mass body 130 may be formed in for example a cylindrical shape, and the post 140 may be formed in a hexagonal shape having a cylindrical hollow hole at the center thereof. When viewed from a transverse cross-section, the mass body 130 is formed in a circular shape, and the post 140 is formed in a rectangular shape having a cylindrical opening at the center thereof. The shapes of the mass body 130 and the post 140 are not limited thereto, and the mass body 130 and the post 140 may be formed in any shape known in the art.

The membrane 110, the mass body 130 and the post 140 may be formed by selectively etching a silicon-on-insulator (SOI) substrate where MEMS (Micro Electro Mechanical System) processing may be easily carried out. Thus, a silicon oxide layer 117 (SiO₂) of the SOI substrate may remain between the mass body 130 and the membrane 110 and between the post 140 and the membrane 110. The membrane 110, the mass body 130 and the post 140 need not be necessarily formed by etching the SOI substrate, or alternatively may be formed by etching a typical Si substrate.

The cap 150 functions to protect the mass body 130, and may be formed of a Si substrate. The peripheral portion 155 of the cap 150 is bonded to the lower surface of the post 140 so as to cover the mass body 130 and the post 140. The peripheral portion 155 of the cap 150 and the lower surface of the post 140 may be bonded to each other using low-temperature silicon direct bonding. Thus, because the cap 150 may be bonded to the post 140 without the use of an additional adhesive, driving and sensing errors occurring as a result of the adhesive not being formed to a uniform thickness may be prevented in advance. Such a low-temperature silicon direct bonding process will be described in detail in the manufacturing method. Meanwhile, the cap 150 has a cavity 157 which is depressed in a thickness direction from the upper surface thereof, so that damping force of air that acts on the mass body 130 may decrease thus improving the dynamic characteristics. Additionally, the cavity 157 may have stoppers 159 that protrude in a direction of the mass body 130 (FIG. 1B), so that the downside displacement of the mass body 130 is limited.

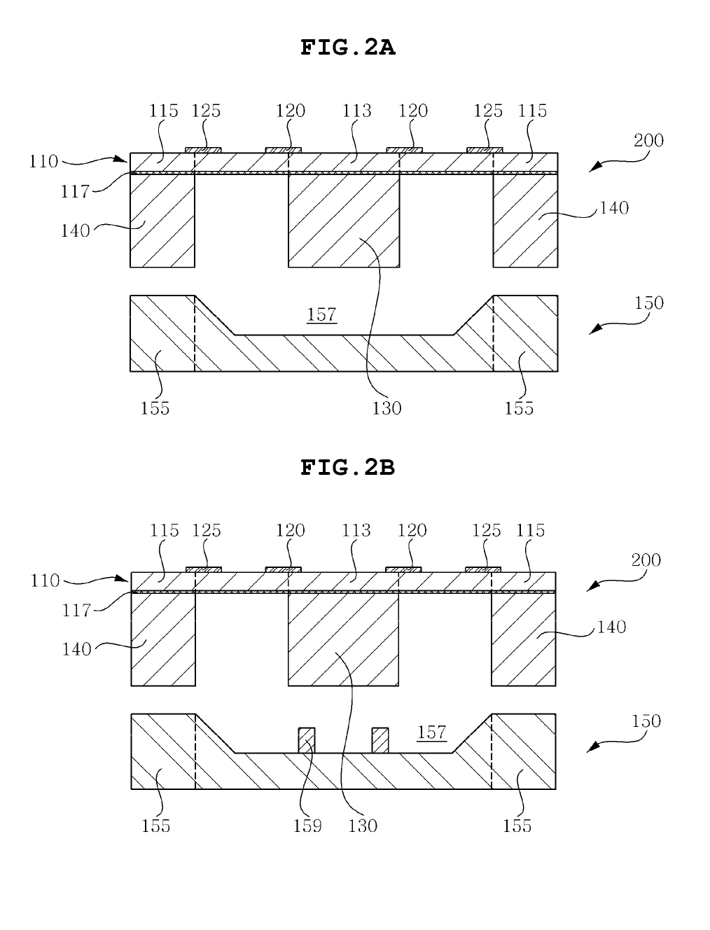

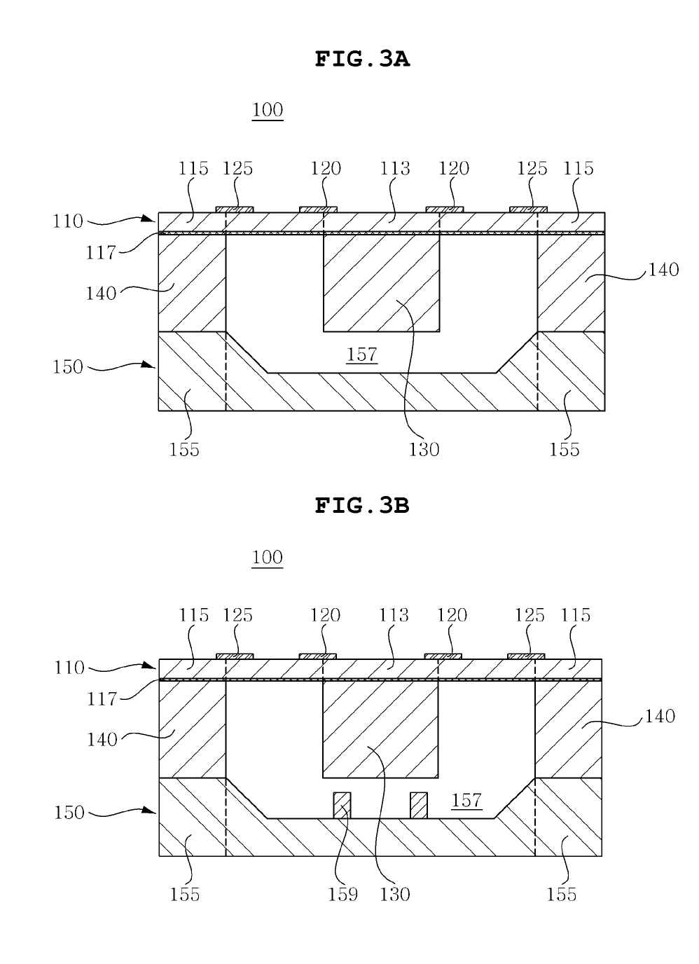

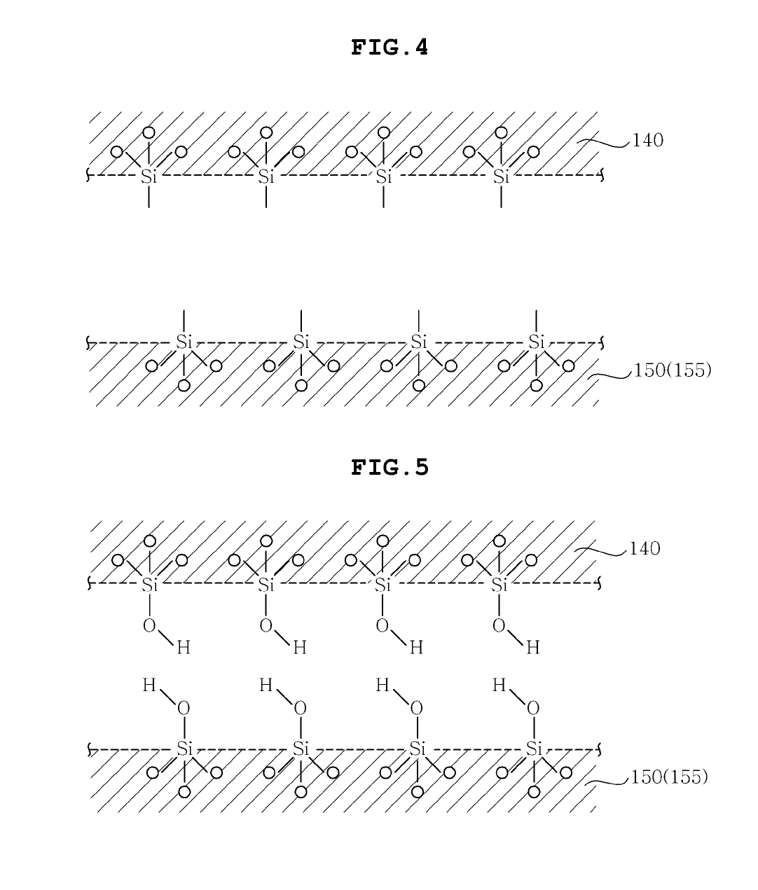

FIGS. 2A, 2B, 3A and 3B are cross-sectional views sequentially showing the process of manufacturing the inertial sensor according to an embodiment of the present invention.

As shown in FIGS. 2A, 2B, 3A and 3B, the inertial sensor 100 according to the present embodiment is manufactured by (A) preparing a base member 200 including a membrane 110, a mass body 130 provided underneath the central portion 113 of the membrane 110 and a post 140 provided underneath the peripheral portion 115 of the membrane 110, and a cap 150, and (B) bonding the peripheral portion 155 of the cap 150 and the lower surface of the post 140 to each other using low-temperature silicon direct bonding.

As shown in FIGS. 2A and 2B, the base member 200 and the cap 150 are prepared. The base member 200 includes the membrane 110, the mass body 130 provided underneath the central portion 113 of the membrane 110, and the post 140 provided underneath the peripheral portion 115 of the membrane 110, and the base member has a fundamental configuration of the inertial sensor 100 except for the cap 150. On the other hand, the cap 150 may have a cavity 157 depressed in a thickness direction, and the cavity 157 may have stoppers 159 that protrude in a direction of the mass body 130 (FIG. 2B).

Next, as shown in FIGS. 3A and 3B, the peripheral portion 155 of the cap 150 and the lower surface of the post 140 are bonded to each other using low-temperature silicon direct bonding. Because both the post 140 and the cap 150 include Si, they may be bonded to each other using low-temperature silicon direct bonding.

FIGS. 4 to 7 are chemical structure views sequentially showing the process of bonding the cap and the post of FIGS. 3A and 3B using low-temperature silicon direct bonding. With reference to these drawings, low-temperature silicon direct bonding is specified below.

First, as shown in FIG. 4, the peripheral portion 155 of the cap 150 and the lower surface of the post 140 are subjected to dry etching. When the peripheral portion 155 of the cap 150 and the lower surface of the post 140 are subjected to dry etching, the peripheral portion 155 of the cap 150 and the lower surface of the post 140 are cleaned, and dangling atoms in a state of being not coupled are exposed. The kind of dry etching is not particularly limited but reactive ion etching may be applied. The reactive ion etching is performed in such a manner that chemical reaction and physical collision of ions formed by plasma are carried out at the same time to conduct etching, and the period of time ranging from about ones to about tens of seconds is required.

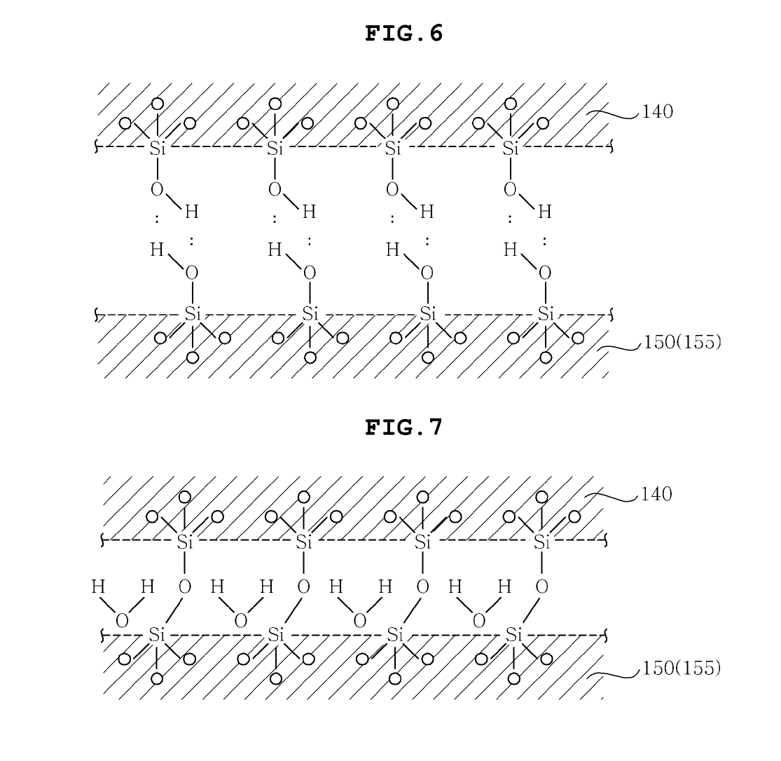

Next, as shown in FIG. 5, the peripheral portion 155 of the cap 150 and the lower surface of the post 140 are exposed to deionized water. When the peripheral portion 155 of the cap 150 and the lower surface of the post 140 are exposed to deionized water, the dangling atoms may be coupled with ions such as OH group. Exposing the peripheral portion 155 of the cap 150 and the lower surface of the post 140 to deionized water may be carried out via a variety of methods. For example, immersion in deionized water in a liquid phase or spraying deionized water in a gas phase may be adopted. On the other hand, the period of time required for exposing the peripheral portion 155 of the cap 150 and the lower surface of the post 140 to deionized water may be about 5 min.

Next, the peripheral portion 155 of the cap 150 and the lower surface of the post 140 are dried. As such, the peripheral portion 155 of the cap 150 and the lower surface of the post 140 may be dried for about 15 min using for example spin drying.

Next, as shown in FIG. 6, the peripheral portion 155 of the cap 150 and the lower surface of the post 140 are brought into close contact with each other so that they are mutually bonded. When the peripheral portion 155 of the cap 150 and the lower surface of the post 140 are brought into close contact with each other, molecules are mutually coupled by Van der Waals force between the OH groups attached to the dangling atoms. This bonding is carried out for about 10 min.

As mentioned above, when dry etching and then bonding are performed, the process time may be shorter compared to when performing wet etching and then bonding. Furthermore, bonding following dry etching enables the molecules to be mutually coupled by Van der Waals force, thus enhancing bonding strength compared to when performing bonding following wet etching. Such an increase in the bonding strength is considered to be because a larger number of dangling atoms may be formed on the surface, so that such dangling atoms are coupled with OH groups, and consequently Van der Waals force that is an attractive force may increase.

Next, as shown in FIG. 7, the bonding strength between the peripheral portion 155 of the cap 150 and the lower surface of the post 140 which were bonded to each other may be further enhanced via thermal treatment. When the thermal treatment is performed, parts of the hydrogen and oxygen atoms present between the peripheral portion 155 of the cap 150 and the lower surface of the post 140 are converted into water (H₂O) and removed, and the peripheral portion 155 of the cap 150 and the lower surface of the post 140 are more strongly bonded to each other via mutual diffusion of the atoms therebetween. The thermal treatment may be conducted at about 200° C. or less, and particularly in the temperature range from room temperature to 100° C. The thermal treatment may be carried out for about 1 hr, and among a variety of thermal treatment methods, annealing may be applied.

Conventional thermal treatment requires most of the process time in the total bonding process, and is conducted for about 10 hr including the heating time of a furnace and the cooling time. Whereas, the low-temperature silicon direct bonding according to the present invention completes the bonding via thermal treatment at a low temperature of 200° C. or less for about 1 hr, drastically reducing the process time and increasing the productivity of the inertial sensor 100. When compared in terms of the total bonding process, the conventional process requires about 11 hr 30 min but the low-temperature silicon direct bonding according to the present invention needs about 1 hr 30 min. Hence, the low-temperature silicon direct bonding according to the present invention may drastically shorten the bonding process time.

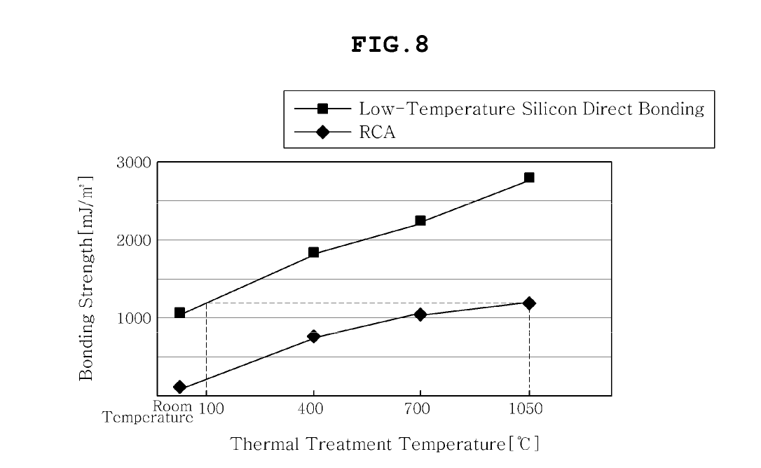

FIG. 8 is a graph showing the bonding strength results of the present invention and the conventional case. With reference to FIG. 8, the bonding strength results of the present invention and the conventional case are compared and described below.

As shown in FIG. 8, the low-temperature silicon direct bonding according to the present invention may result in much stronger bonding strength compared to conventional RCA. Specifically, upon conventional RCA, bonding strength after thermal treatment at a high temperature of about 1050° C. is similar to the bonding strength after thermal treatment at room temperature by the low-temperature silicon direct bonding according to the present invention, and is almost the same as that after thermal treatment at about 100° C.

Ultimately, the low-temperature silicon direct bonding according to the present invention may result in necessary bonding strength even when thermal treatment is carried out at a comparatively low temperature. Thus, the furnace used in the conventional RCA (about 1000° C.) may be replaced with a hot plate having heating wires in the low-temperature silicon direct bonding according to the present invention.

Also when the low-temperature silicon direct bonding according to the present invention is performed, an increase in the bonding strength depending on the temperature of the thermal treatment may be much higher, compared to when using conventional RCA. Thus in the case of the low-temperature silicon direct bonding according to the present invention, when higher bonding strength is required, the temperature of thermal treatment may be increased, whereby the bonding strength may be remarkably enhanced, compared to conventional RCA.

Furthermore, when thermal treatment is performed at high temperature as in the conventional bonding process such as RCA, voids may be formed between the peripheral portion 155 of the cap 150 and the lower surface of the post 140, or the inertial sensor 100 may warp. However, in the case of the low-temperature silicon direct bonding according to the present invention, even when thermal treatment is performed at a lower temperature of 200° C. or less, sufficient bonding strength may be obtained, thus preventing the generation of voids or warpage. Also, because the low-temperature silicon direct bonding according to the present invention does not cause voids as mentioned above, bonding defects may be detected via IR testing after the bonding process.

As described hereinbefore, the present invention provides an inertial sensor and a method of manufacturing the same. According to the present invention, a cap can be bonded to a post using low-temperature silicon direct bonding, thus obviating the need for an additive, thereby preventing driving and sensing errors occurring as a result of the adhesive not being formed to a uniform thickness.

Also according to the present invention, because the cap is bonded to the post using low-temperature silicon direct bonding, voids are not generated, thus detecting bonding defects via IR testing after the bonding process.

Although the embodiments of the present invention regarding the inertial sensor and the method of manufacturing the same have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. An inertial sensor, comprising:
a membrane;
a mass body provided underneath a central portion of the membrane;
a post provided underneath a peripheral portion of the membrane; and
a cap having a peripheral portion bonded to a lower surface of the post using low-temperature silicon direct bonding.

2. The inertial sensor of claim 1, wherein the low-temperature silicon direct bonding comprises:
(A) subjecting the peripheral portion of the cap and the lower surface of the post to dry etching;
(B) exposing the peripheral portion of the cap and the lower surface of the post to deionized water; and
(C) bringing the peripheral portion of the cap and the lower surface of the post into close contact with each other so as to be mutually bonded.

3. The inertial sensor of claim 2, wherein in (A), the peripheral portion of the cap and the lower surface of the post are subjected to dry etching, thus exposing a dangling atom in a state of not being coupled,
in (B), the peripheral portion of the cap and the lower surface of the post are exposed to deionized water, thus coupling the dangling atom with an OH group, and
in (C), the peripheral portion of the cap and the lower surface of the post are brought into close contact with each other, so that they are mutually bonded by Van der Waals force.

4. The inertial sensor of claim 2, wherein in (A), the dry etching is reactive ion etching.

5. The inertial sensor of claim 2, wherein thermally treating the peripheral portion of the cap and the lower surface of the post is additionally performed, after (C).

6. The inertial sensor of claim 5, wherein the thermally treating is performed using annealing at 200° C. or less.

7. The inertial sensor of claim 5, wherein the thermally treating is performed using a hot plate.

8. The inertial sensor of claim 2, wherein drying the peripheral portion of the cap and the lower surface of the post is additionally performed, after (B).

9. The inertial sensor of claim 1, wherein the cap has a cavity depressed in a thickness direction.

10. The inertial sensor of claim 9, wherein the cavity has a stopper that protrudes in a direction of the mass body.

11. A method of manufacturing an inertial sensor, comprising:
(A) preparing a base member comprising a membrane, a mass body provided underneath a central portion of the membrane and a post provided underneath a peripheral portion of the membrane, and a cap; and
(B) bonding a peripheral portion of the cap and a lower surface of the post to each other using low-temperature silicon direct bonding.

12. The method of claim 11, wherein (B) comprises:
(B1) subjecting the peripheral portion of the cap and the lower surface of the post to dry etching;
(B2) exposing the peripheral portion of the cap and the lower surface of the post to deionized water; and
(B3) bringing the peripheral portion of the cap and the lower surface of the post into close contact with each other so that they are mutually bonded.

13. The method of claim 12, wherein in (B1), the peripheral portion of the cap and the lower surface of the post are subjected to dry etching, thus exposing a dangling atom in a state of not being coupled,
in (B2), the peripheral portion of the cap and the lower surface of the post are exposed to deionized water, thus coupling the dangling atom with an OH group, and
in (B3), the peripheral portion of the cap and the lower surface of the post are brought into close contact with each other, so that they are mutually bonded by Van der Waals force.

14. The method of claim 12, wherein in (B1), the dry etching is reactive ion etching.

15. The method of claim 12, wherein thermally treating the peripheral portion of the cap and the lower surface of the post is additionally performed, after (B3).

16. The method of claim 15, wherein the thermally treating is performed using annealing at 200° C. or less.

17. The method of claim 15, wherein the thermally treating is performed using a hot plate.

18. The method of claim 12, wherein drying the peripheral portion of the cap and the lower surface of the post is additionally performed, after (B2).

19. The method of claim 11, wherein the cap has a cavity depressed in a thickness direction.

20. The method of claim 19, wherein the cavity has a stopper that protrudes in a direction of the mass body.
